(19) United States
(12) Patent Application Publication
(10) Pub. No.: US 2004/0004945 A1
(43) Pub. Date: Jan. 8, 2004

(54) Multiple access network and method for digital radio systems

(76) Inventor: Peter Monsen, Stowe, VT (US)

Correspondence Address: Peter J Manus Dike Bronstein Roberts & Cushman, Edwards & Angell, Intellectual Property Practice Group, PO Box 9169, Boston, MA, 02209, US

(21) Appl. No.: 10/399,706

(22) PCT Filed: Oct. 22, 2001
(86) PCT No.: PCT/US01/46692

(51) Int. Cl. H04Q 7/00

(52) U.S. Cl. 370/328; 370/508

(57) ABSTRACT

A multiple-access digital radio communication network and method with communication uplinks between user terminal transmitters and central nodes that are connected with fixed communication links. User terminal transmitters are assigned to beam/node regions corresponding to an associated central node and their location within the central node antenna beam coverage area. User terminal transmitters assigned to one beam/node coverage region use multiple access channels that are mutually orthogonal for transmitting digital message information. These multiple access channels are reused in adjacent and other beam/node coverage regions. Error-correction coding (25), interleaving (26), and a modulator (29) are used in the user transmitter to increase resistance to potential interference from user terminal transmitters in other beam/node coverage regions. At a central node, an uplink receiver (21) provides digitized beam/node signals to a multiuser detector (23) and via the fixed communication links to multiuser detectors at adjacent central nodes. At the multiuser detector an adaptive processor (32) such as an equalizer or sequence estimator is used to combine beam/node signals from the present central node and adjacent central nodes to produce combined signals each associated with a particular user terminal transmitter. The combining in the adaptive processor reduces interference from user terminal transmitters associated with different beam/node coverage regions but with the same multiple access channel. Deinterleaving (34) and error-correction decoding (35) of the combined signal is used to complete the recovery of the digital message information.

### FIELD OF THE INVENTION

This invention relates generally to multiple access communication in a network of digital radio systems, and more particularly to improvements in the multiple access communication of fixed remote user terminals and/or mobile user terminals associated with central nodes having antennas with one or more antenna beams.

### BACKGROUND OF THE INVENTION

A network of multiple access radio systems provides communication services for fixed remote user terminals and/or mobile user terminals. Examples of multiple access radio networks include land mobile radio networks, cellular mobile radio networks, and wideband radio networks between fixed subscribers and one or more central nodes, which may use a multibeam antenna for increasing system capacity and improving communications quality. The reverse link or uplink in a multiple access radio system is a communications link between a fixed remote or mobile user terminal and a central node, which can be located at either a fixed location on the Earth in a terrestrial radio system or in a satellite repeater/ground station in a satellite radio system.

A network of multiple access radio systems use many central nodes or base stations in order to cover a large geographical area. The central nodes are connected together with fixed communication links, i.e., telephone lines, fiber optic cable, high speed radio links, etc., for purposes of coordinating central node operations in the network. The interconnection between central nodes may also be used to support macrodiversity, which is a large scale form of space diversity. For an uplink transmission there are multiple diversity paths to different central nodes. A macrodiversity system selects the best diversity path signal to reduce fading effects based on quality measurements that are transmitted over the fixed communication links.

Central nodes that are part of a common communications network and are sited sufficiently close to one another that mutual interference among channels in their beam regions can occur unless controlled, will be termed herein as “neighbors”.

Digital radio systems transmit and receive digital message information, e.g., computer or Internet data. Alternatively, digital radio systems accept analog message information, e.g., voice or video data, and convert this analog information to a digital format during transmission and reception. Accordingly, a fixed remote or mobile user terminal transmits message information in a digital format using an uplink to a central node, where one or more antennas and an associated receiver process received signals to extract user message information. In some satellite radio systems, the receiver processing is divided between a satellite repeater and a ground-based station processor.

The antenna at a central node may be fixed with either a single or multiple beams providing coverage for one or more beam regions associated with the central node. Alternatively the antenna at the central node may be multibeam and adaptive thereby producing multiple beam regions that adapt the beam characteristics to the group of user terminal locations associated with the beam region. Because of the overlap of antenna beam patterns, interference can occur between user terminals in different beams of the same central node and between user terminals in beams of different central nodes. In general for each central node and antenna beam there is an associated beam/node region.

User terminals located within the same beam/node region generally avoid mutual interference through the use of some form of multiple access scheme. Conventional multiple access radio services use Frequency Division Multiple Access (FDMA), Time Division Multiple Access (TDMA), Code Division Multiple Access (CDMA), or some combination thereof. Generally, FDMA separates users into different frequency subbands; TDMA separates users into different time intervals or slots; and, CDMA separates users by assigning different signature waveforms or spreading codes to each user. These CDMA spreading codes can be either orthogonal, i.e., there is no interference between synchronized users, or quasi-orthogonal, ie., there is some small interference between users. FDMA and TDMA are orthogonal multiple access (OMA) schemes because with ideal frequency filters and synchronization there is no mutual interference. Another example of an OMA system is CDMA with orthogonal spreading codes. Quasi-Orthogonal Multiple Access (QOMA) systems include CDMA with quasi-orthogonal spreading codes and FDMA/TDMA with randomized frequency hopping.

In both orthogonal and quasi-orthogonal multiple access systems, the multiple access channels are usually assigned by a centralized controller which may make assignments for a group of beam/node coverage regions. The assignments to the user terminals are normally transmitted in time division with downlink message information. After synchronization, user terminals can extract the channel assignment data from the downlink messages.

For an isolated beam, an OMA scheme generally provides a larger system capacity than a QOMA scheme. However, when other beam/node regions are taken into account, practical systems often use QOMA schemes for reducing interference between users to acceptable levels.

Interference between a user in one beam/node region and users in other beam/node regions is normally reduced by distance and antenna beam discrimination resulting in cross-channel attenuation. However, in OMA radio systems, such cross-channel attenuation usually does not reduce interference enough to allow the reuse of the same orthogonal waveform or channel in adjacent beam/node regions. Instead, channel management is typically required for determining when a multiple access channel can be reused in another beam/node region depending on an allowable threshold of the user/beam cross-channel attenuation. This leads to a reuse factor that is less than 1. The reuse factor of a multiple access channel is defined as the number of user terminal assignments to that channel in different beam/node coverage regions divided by the total number of beam/node coverage regions. Because the capacity of a multiple access system is proportional to the average value of the reuse factor with respect to all the multiple access channels, it is desirable to make the reuse factor for each multiple access channel as large as possible subject to interference constraints. Distance, attenuation, and practical limitations on multibeam antennas typically cause the reuse factor in cellular OMA systems to vary between ⅓ and 1/12. Thus, in known systems, the assignment of channels to users is restricted by distance and attenuation considerations. A multiple access communication system or method not so constrained is characterized herein as “unrestricted”.

In applicant's “Multiple Access System and Method for Multibeam Digital Radio Systems”, Patent Application PCT/US00/12802, filed 11 May 2000, a system and method is disclosed for achieving a unity reuse factor in an OMA system associated with a central node and its associated multibeam antenna. The unity reuse factor is achieved with a combination of error-correction coding/decoding, interleaving/deinterleaving, single axis modulation, and interference processing at the central node. Patent Application PCT/US00/12802 does not disclose techniques for achieving unity reuse for all beam/node regions in systems with multiple central nodes that may have either omnidirectional or multibeam antennas.

In contrast, in a network of QOMA radio systems, e.g., uplinks of CDMA radio systems in the IS-95 standard, the reuse factor can be unity because the combination of user/beam cross-channel attenuation and spreading code interference protection is sufficient to keep mutual interference between users in different beam/node regions to adequately small levels. However, one drawback is that a QOMA radio system generally has a theoretical capacity that is less than that of an OMA radio system.

Conventional multiple access digital radio systems provide means for error-correction coding/decoding of message information, means for interleaving/deinterleaving the message information, and a transmission format for the message information that includes reference signal sub-blocks. The reference signal is generated at both the user terminal and the central node and used by the central node receiver for obtaining channel parameters to aid in demodulating a user signal. The insertion of a known reference signal in time multiplex with the transmitted message information is described in “An Adaptive Receiver for Digital Signaling through Channels with Intersymbol Interference”, J. G. Proakis and J. H. Miller, IEEE Transactions on Information Theory, vol. IT-15, No. 4, July 1969 and in U.S. Pat. No. 4,365,338. Error-correction coding adds redundancy to message information in a prescribed manner so that transmission errors may be corrected with a decoder at the receiver. The purpose of the interleaver/deinterleaver is to randomize these transmission errors at the decoder input so as to make the decoder more capable of correcting them.

Further, the message information conventionally undergoes quadrature transmission, wherein two carriers in phase quadrature to one another, e.g., cos ω_{c}t and sin ω_{c}t, are simultaneously transmitted using the same channel. Quadrature transmission is an example of a multisymbol signaling scheme, wherein pluralities of successive binary digits of user data are combined to form symbols to be transmitted. Such multisymbol signaling schemes are typically used to reduce the bandwidth required to transmit the user data. Quadrature amplitude modulation (QAM) is an example of a general multisymbol signaling scheme, wherein multilevel amplitude modulation is applied separately on each of the two quadrature carriers. The aforementioned patent application PCT/US00/12802 discloses using a multisymbol signaling scheme in only one of the two quadrature axes, i.e., single axis modulation, in a multiple access system with a single central node and multibeam antenna.

Conventional macrodiversity systems in cellular networks use fixed network connectivity between central nodes to implement diversity selection techniques amongst multiple paths between the user terminal transmitter and central nodes. In these systems the required signal-quality information is transferred over the communication links between central nodes. The quality information might be the estimated signal-to-noise ratio for a frame of received signals. By comparing quality measures such as signal-to-noise ratio, the system can decide which transmission path to select. The transmission of quality information rather than the received signals themselves is much simpler and requires less channel capacity on the fixed communication links. In “The Multiply-Detected Macrodiversity Scheme for wireless Cellular Systems” by Z. J. Hass and C. Li, IEEE Trans. On Vehicular Technology, vol. 47, No 2, May 1998, pg. 506-530 [hereafter denoted by Macrodiversity Scheme], the uplink signals are detected at each central node and signal decisions are sent to a central point where diversity combining is accomplished. In Macrodiversity Scheme it is recognized that better diversity combining can be achieved with distribution of received signals over the fixed network to the central point but at a cost of larger fixed network traffic. The use of received signals rather than decisions at the central point was considered by Macrodiversity Scheme as “future research”, pg. 507, 2^{nd} paragraph. This future research area would include methods of synchronizing the signals at the central point and methods of combining as well as cancellation of undesired signals.

In particular, a macrodiversity system that combines received signals must compensate for changes in other user interference delays when user locations change as a result of a modulation-hopping scheme. Moreover the synchronization or lack there of between central node clocks will effect combining techniques in a macrodiversity scheme.

The use of fixed communication links for transferring received signals between central nodes is not usually considered as in Macrodiversity Scheme because of the capacity utilization required in the fixed communication link network. However, if a dramatic improvement in the mobile network capacity could be achieved as a result of those transfers, the much lower cost of the fixed network facilities would make such a scheme economically attractive.

Some conventional digital radio systems use adaptive equalizers for combining multipath signals and reducing intersymbol interference. Adaptive equalizers have also been proposed for use with a multibeam receiver for reducing interference from other users.

MMSE Equalization of Interference on Fading Diversity Channels, Peter Monsen, IEEE Conference on Communications, Conference Record, Vol.. 1, Denver, Col., June 1981, pp. 12.2-1-12.2-5, describes an adaptive equalizer that combines multipath signals and reduces intersymbol and other user interference. The total interference is included in an error signal whose mean square value is minimized. Transmission of a time division multiplexed reference that is known at the receiver is also described.

U.S. Pat. Nos. 4,112,370 and 4,644,562 disclose the cancellation of interference in multibeam antennas as a generalization of the cancellation of interference in dual-polarized antennas.

U.S. Pat. No. 5,680,419 discloses adaptive sequence estimation techniques that can be used with a multibeam antenna for canceling interference. Adaptive Equalization and Interference Cancellation for Wireless Communication Systems, B. C. W. Lo and K. B. Letaief, IEEE Trans. Comm., vol. 47, no. 4, April 1999, pp. 538-545 discloses in a multiantenna application a maximum likelihood sequence estimation technique that uses a reference signal of the desired user in order to detect a user signal in the presence of intersymbol interference and other user interference. Although either an equalizer or a sequence estimator or a combination of both can be used for adaptive processing, the equalizer is generally preferred because it is not as complex as the sequence estimator.

Other patent documents and publications in this area include U.S. Pat. No. 5,838,742; Dynamic Channel Assignment in High-Capacity Mobile Communications Systems, D. C. Cox and D. O. Reudick, Bell System. Tech. Journal, vol. 51, pp. 1833-2857, July-August 1971; MMSE Equalization on Fading Diversity Channels, P. Monsen, IEEE Transactions on Communications, vol. COM-32, No. 1, pp. 5-12, January 1984; Linear Multiuser Detectors for Synchronous Code-Division Multiple Access Channels, R. Lupas and S. Verdu, IEEE Transactions on Information Theory, vol. IT-35, No. 1, pp. 123-136, January 1989; Decorrelating Decision-Feedback Multiuser Detector for Synchronous Code-Division Multiple Access Channels, A. Duel-Hallen, IEEE Transactions on Communications, vol. COM-41, No. 2, pp. 285-290, February 1993; A Family of Multiuser Decision Feedback Detectors for Asynchronous Code-Division Multiple Access Channels, A. Duel-Hallen, IEEE Transactions on Communications, vol. COM-43, Nos. 2, 3, 4, February-April 1995; Information-Theoretic Considerations for Symmetric, Cellular, Multiple Access Fading Channels-Part I, S. Shamai and A. D. Wyner, IEEE Transactions on Information Theory, vol. 43, No. 6, pp 1877-1894, November 1997; and, Mobile Station-Base Station Compatibility Standard for Dual-Mode Wideband Spread Spectrum Cellular System, EIA/TIA IS-95, 1992.

Although the techniques described above have been used for improving communications quality and increasing the capacity of multiple access communication systems, it has been recognized that the capacity of a network of OMA systems with multiple central nodes is limited because its multiple access channels have reuse factors less than 1. It has also been recognized that the capacity of QOMA systems is limited because its theoretical capacity is less than that of a corresponding OMA system.

### SUMMARY OF THE INVENTION

With the foregoing background in mind, it is an object of the invention to provide a multiple access communication network and method with increased channel capacity and improved communications quality.

Another object of the invention is to provide a multiple access communication network and method that is orthogonal in each beam/node coverage region and has a channel capacity greater than that of conventional quasi-orthogonal multiple access communication systems.

Still another object of the invention is to provide an orthogonal multiple access communication network and method that has a reuse factor of unity where there are multiple central nodes with time clocks that may not be mutually synchronous.

The foregoing and other objects are achieved in a multiple access communication network including a plurality of user terminals, each including a user terminal transmitter; and a plurality of central nodes each including an antenna and associated receiver for receiving digital message information transmitted by the user terminal transmitters. In the network, central nodes are connected together with fixed network of communication links, e.g.. telephone lines, fiber optic cable, high speed radio links, etc., for purposes of coordinating central node operation and also performing remote signal processing.. The antenna at the central node may be omnidirectional, i.e. a single beam provides uplink coverage, or multibeam, either fixed or adaptive, resulting in beam/node coverage regions or sectors for that central node. For each beam and each central node there is a beam/node region wherein user terminal transmitters are located. Those user terminal transmitters associated with a beam/node coverage region employ mutually orthogonal multiple access waveforms. User transmitter terminals associated with other beam/node coverage regions can reuse the same orthogonal waveforms from the mutually orthogonal waveform set.

In a preferred embodiment, the user terminal transmitter includes a coding unit for providing error-correction coding of the digital message information, an interleaving unit for distributing the error-correction coded message information, a multiplexer for multiplexing user reference signals with the error-correction coded message information, and a modulator for modulating the multiplexed signal for subsequent transmission as a respective multiple access signal, wherein each of the respective multiple access signals associated with a beam/node coverage region employ an orthogonal waveform from a mutually orthogonal waveform set. An assignment controller that may be colocated with a central node or distributed in the network provides channel assignments from the mutually orthogonal set. These channel assignments are sent to the user terminal by a downlink radio link.

The modulator in the user terminal transmitter may also modify the radio frequency (RF). characteristics corresponding to a group or packet of multiplexed data containing at least one reference signal subblock. In the preferred embodiment each user is modulation hopped to a new multiple access channel for transmission of the packet. In some systems the radio frequency modification can be omitted because user terminal motion provides a similar effect.

In the preferred embodiment at a central node, an uplink receiver includes an antenna for receiving respective multiple access signals from the user terminal transmitters in each of the one or more antenna beams resulting in a plurality of beam/node signals for the present central node, one or more link receivers for receiving beam/node signals received at an adjacent central node and retransmitted over the fixed network connecting the central nodes, an adaptive processor for each user that processes beam/node signals and the reference signals to combine the beam/node signals and reduce other user interference, and a deinterleaver and decoder for each user to recover the digital message information from the combined signal. Prior to the adaptive processor, a delay compensator adjusts the delays of beam/node signals from the present central node and beam/node signals from the adjacent central nodes to time align the received signal packets.

Modulation hopping randomizes the other user interference, which after the deinterleaving/decoding operation averages the effects of other user interference. The error-correction coded information is interleaved before transmission so that after deinterleaving at the receiver, the other user interference associated with successive error-correction coded symbols is different. The interleaving thus improves the error-correcting capability of the decoder and increases the interference protection. In general every user may employ a unique reference signal so that the receiver can extract channel information for that user by generating a replica of the unique reference signal and processing it with the received beam/node signals. Since users within the same beam/node coverage region are assigned channels from a mutually orthogonal set, these users may employ the same reference signal. At the receiver there is an adaptive processor for each user and this adaptive subsystem processes the beam/node signals that contain significant adjacent beam interference. In the preferred embodiment the adaptive processor is a multiuser decision-feedback equalizer (MDFE) that minimizes a mean square error by solving a set of simultaneous equations for each received data group. The solution of these equations provides the processor settings for that received group. The user reference signal for a respective beam/node coverage region and user reference signals corresponding to interfering beams are employed to determine the adaptive processor parameter settings in this embodiment. The MDFE provides diversity combining of signals and reduction of other user interference. In doing so it compensates for both multipath effects between user terminals and antennas as well as path delay differences due to changing interference effects. The MDFE can be used with both synchronous and asynchronous central nodes.

Still further objects and advantages will become apparent from a consideration of the ensuing description and drawings.

### BRIEF DESCRIPTION OF THE DRAWINGS

The invention will be better understood by reference to the following more detailed description and accompanying drawings in which:

FIG. 1 is a diagram of beam/node regions in a multiple access network according to the present invention with multiple central nodes some of which contain multibeam antennas;

FIG. 2 is a diagram of a packet for transmission in the communication network according to the present invention;

FIG. 3 is a functional block diagram of a central node connected to an assignment controller according to the present invention.

FIG. 4 is a functional block diagram of a user terminal transmitter in the communication network of the present invention;

FIG. 5 is a functional block diagram of a multiuser detector at a central node according to the present invention; and

FIG. 6 is a diagram of received packet intervals for multiple central nodes with asynchronous timing clocks.

### DETAILED DESCRIPTION OF THE INVENTION

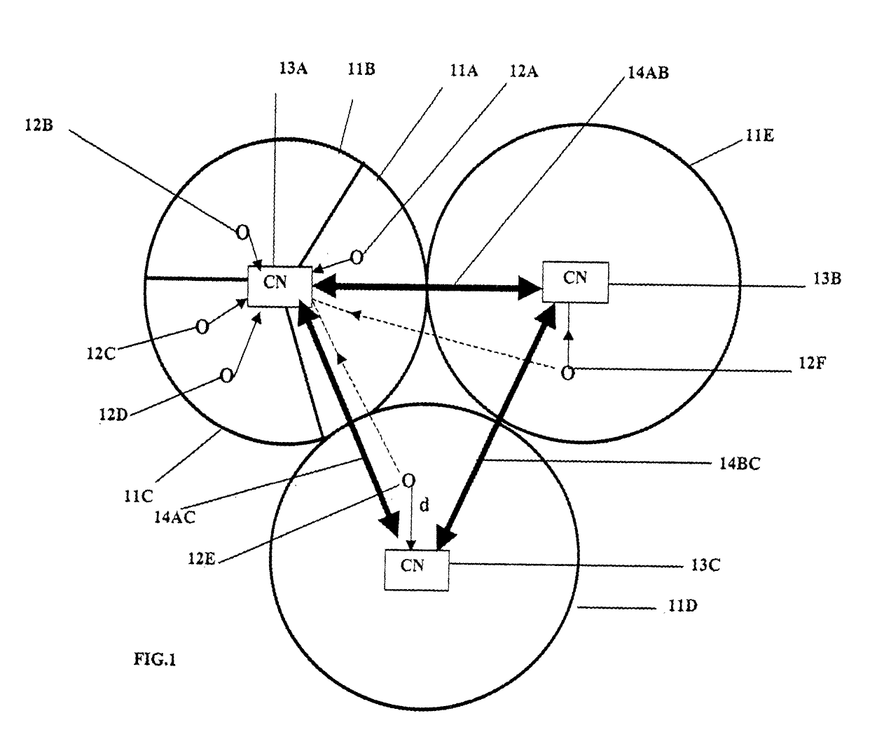

FIG. 1 shows an uplink multiple access network with a plurality of beam/node regions 11 within which user terminal transmitters 12 are assigned to central nodes 13, i,e, base stations, for purposes of transmitting message information from a user terminal to its assigned central node 13. Each central node 13 may have one or more associated beam/node regions. Omnidirectional coverage and a single beam region per central node are shown in FIG. 1 as region 11E, node 13B and region 11D, node 13C. The use of multibeam antennas, either fixed or adaptive, can provide multiple beam/node regions or sectors, 11A, 11B, and 11C associated with a single central node 13A. The beam/node coverage regions typically overlap because antenna beams do not have ideal cutoff transitions. A user terminal transmitter 12 is usually assigned to a user terminal beam/node coverage region 11 depending on geographic location and antenna beam response characteristics.

The central nodes 13 are connected together with fixed communication links 14 that are generally used to coordinate central node operations in the network. These links may be dedicated telephone lines, fiber optic cable, or high speed radio circuits, all of which can generally support high transmission rates. In FIG. 1 a fixed communication link 14AB connects central nodes 13A and 13B, link 14BC connects nodes 13B and 13C, and link 14AC connects nodes 13A and 13C.

Central nodes 13 contain timing clocks (not shown) that are used to provide timing for digital transmission of information. In certain multiple access radio networks the central node clocks are maintained in mutual synchronism. This is a preferred choice for this invention because it minimizes receiver complexity at the central node. For networks where mutual synchronism between clocks is not or cannot be maintained, an embodiment of the invention is described wherein the achievement of a unity reuse factor is obtained.

Because of distance factors and cross-beam interference in practical antennas, user terminal transmitters 12 with the same channel assignment but in different beam/node regions will interfere with each other at central node 13 locations. For example, in FIG. 1, user terminal transmitter 12A in sector 11A will have an uplink transmission to central node 13A but this transmission may be interfered with by transmissions to other central nodes, e.g. 13B and 13C, and transmissions to other beams at central node 13A, e.g. from sectors 11B and 11C. In this example user terminal transmitters 12C and 12D are in the same beam/node region so they are assigned mutually orthogonal channels. However, user terminal transmitters 12A, 12B, 12D, 12E, and 12F in the present invention can all be assigned the same orthogonal channel even though there may be significant cross interference. In this example, interference from 12E and 12F (indicated by dotted lines) is reduced by distance effects and interference from 12B and 12D is reduced by antenna discrimination. In conventional systems this interference reduction is usually insufficient to allow this set of user terminal transmitters to all use the same orthogonal channel.

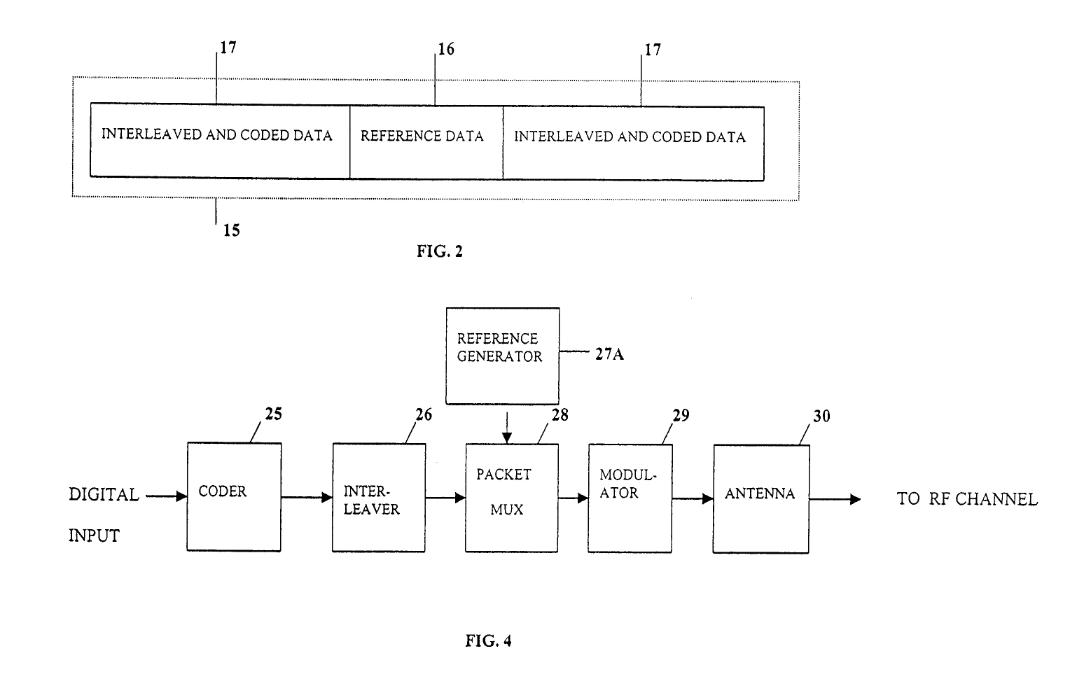

FIG. 2 shows the transmission format for a packet 15 of user message information to be sent over a reverse link or an uplink in a multiple access radio system between a fixed remote user terminal or a mobile user terminal and a central node, which may be located at either a fixed location on the Earth in a terrestrial radio system or in a satellite repeater/ground station in a satellite radio system.

The packet 15 includes a user reference signal that is a block of reference data 16, which is inserted into the packet 15 at the user terminal transmitter. In particular, the reference data 16 includes a sequence of known data symbols (not shown) that may be inserted into the packet 15 either as a contiguous block as depicted in FIG. 2 or in some distributed manner. The sequence of data symbols and the manner in which they are inserted into the packet 15 are known at the central node for each user in the multiple access radio system whose message information is to be processed at that node. Further, the reference data 16 is used for determining adaptive processor parameter settings at the central node, as described in further detail below. One of ordinary skill would recognize that the user reference signal could also be multiplexed with the user message information as a separate signal such as a pilot signal rather than as a time division multiplexed component of a packet.

The packet 15 also includes interleaved and coded data 17, which is representative of processed user message information in digital form. Finally, the packet 15 may include other system or user information (not shown) in addition to the reference data 16 and the interleaved and coded data 17.

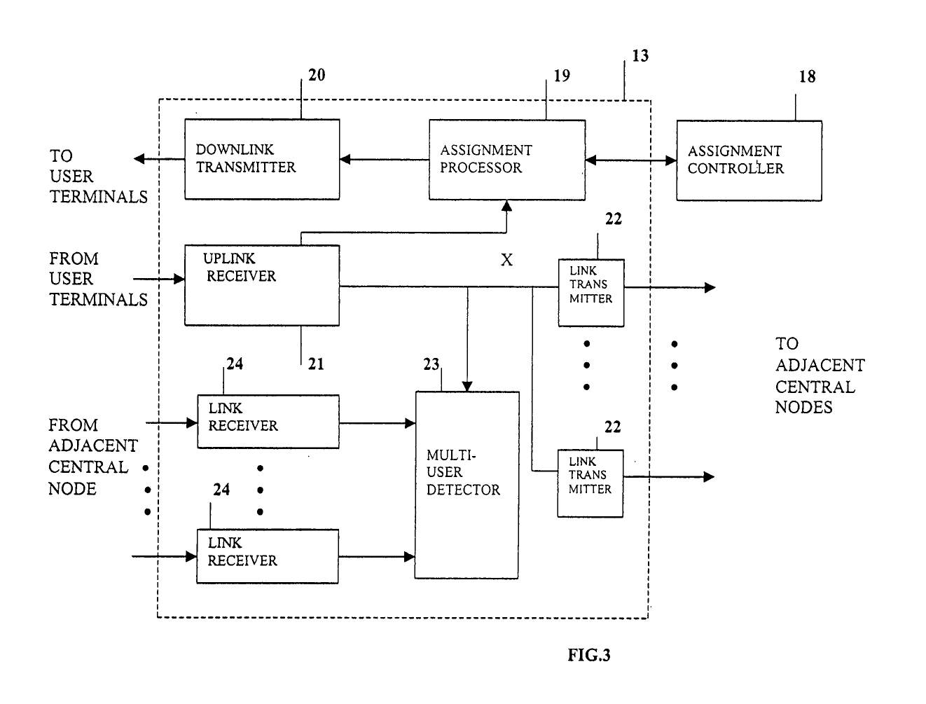

User terminal transmitters 12 associated with the same beam/node coverage region 11 are assigned orthogonal multiple access (OMA) channels from a mutually orthogonal set. Examples of OMA schemes that may be used with the multiple access radio system of the present invention include Frequency-Division Multiple Access (FDMA), Time-Division Multiple Access (TDMA), and Orthogonal-Waveform Code-Division Multiple Access (OCDMA), and various combinations thereof. In the present invention the same multiple access channel may be reassigned to user terminal transmitters in all other beam/node coverage regions for a reuse factor of unity. The assignment of channels to the user terminal transmitter 12 can be accomplished by transmitting assignment data to the user terminal from either the central node or a centralized location that includes multiple central nodes. Assignment data may be time division multiplexed with downlink message transfers or transmitted on a separate channel to the user terminal. With reference to FIG. 3, in the preferred embodiment the multiple access channel assignments are produced by an assignment controller 18 that is either collocated with the central node 13 or is connected to the central node 13 with a communication link (indicated as a double-arrow line in FIG. 3) to transfer assignment data to an assignment processor 19. The assignment processor 19 formats assignment data for downlink transfer to user terminals via a downlink transmitter 20 and it receives status information from the uplink receiver 21 to be described subsequently. This status information is passed on to the assignment controller 18 by the assignment processor 19. The uplink receiver 21 downconverts one or more antenna beam signals from radio frequency to digitized beam/node signals, one for each antenna beam in this present central node. These digitized signals are provided to link transmitters 22 in a fixed network as shown as an example as fixed communication links 14 in FIG. 1 connecting together central nodes so that digitized signals are sent to adjacent central nodes. Returning to FIG.. 3 the digitized beam/node signals are also provided to a multiuser detector 23 to be described subsequently that recovers uplink message information. Link receivers 24 receive digitized beam/node signals from adjacent central nodes via the fixed network and provide these signals to the multiuser detector 23 as inputs to be used in interference cancellation. One of ordinary skill would recognize that the fixed network could also route the digitized signals to some central point as suggested in Macrodiversity Scheme for subsequent signal processing rather than performing the signal processing at the present central node as described herein in connection with the preferred embodiment.

Each user terminal transmitter 12 associated with a particular beam/node coverage region is assigned a multiple access channel from a mutually orthogonal set. Thus user terminal transmitters 12C and 12D associated with the same beam/node coverage region do not interfere with each other under ideal transmission conditions. In the present invention, multiple access channels can be reused in beam/node regions so for example, the user terminal transmitters 12A, 12B, 12D, 12E, and 12F shown in beam/node coverage regions 11A, 11B, 11C, 11D, and 11E, respectively, may be assigned the same multiple access channel by the assignment controller 18.

Before describing in detail a user terminal transmitter 12 and a multiuser detector 23 in accordance with the present invention, it should be understood that the present invention includes conventional communication system components, e.g., error-correction coder/decoder, interleaver/deinterleaver, multiplexer/demultiplexer, modulator/demodulator, and adaptive processor, which perform tasks related to the transmission and/or reception of user message information. Because these communication system components are conventional and known to those skilled in this art, the user terminal transmitter 12 and the multiuser detector 23 have been described through the use of functional block diagrams, wherein each block is representative of one of these conventional communication system components. For the adaptive processor, a preferred construction is identified below.

FIG. 4 shows a preferred embodiment of a user terminal transmitter 12 according to the present invention. User message information to be transmitted on an uplink to a uplink receiver 21 may initially be in either analog or digital form. However, the user message information is preferably converted, if necessary, into digital form before being provided as a digital input to a coder 25, which adds redundancy in the form of an error-correction code, thereby causing the digital transmission rate of coded data at the output of the coder 25 to be greater than the digital input rate at the input of the coder 25. It should be noted that the type, the subclass, and the parameters related to the error-correction code are not critical to the present invention. In a binary communication system an example of an error-correction coding technique would be the rate 1/2, constraint length 7, convolutional code with generators 133, 171.

The coder 25 provides the coded data to an interleaver 26, which distributes the coded data among multiple packets in a predetermined manner. In a preferred embodiment, the coded data is distributed among the multiple packets as follows. If there are N symbols per packet, then the N symbols are evenly distributed over N packets; e.g., symbol 1 goes in packet 1, symbol 2 goes in packet 2, and so on, until symbol N goes in packet N, and then the process is repeated until all N packets are full. However, it should be understood that the interleaver 26 may distribute the coded data into the multiple packets in other ways and still achieve a reuse factor of 1 in the uplink of the OMA system.

A reference generator 27A locally produces the sequence of known data symbols included in the reference data 16 mentioned above, and then provides the reference data 16 to a packet multiplexer 28. The block of reference data 16 that is inserted into packet 15 can be unique to each user or it may be the same for each user in a beam/node coverage region 11 but unique relative to users in other beam/node coverage regions 11 in the multiple access radio network. Similarly, the interleaver 26 provides the interleaved and coded data 17 to the packet multiplexer 28, which then generates packets having the general form shown in FIG. 1. As also mentioned above, each packet may include other system or user information in addition to the reference data 16 provided by the reference generator 27A and the interleaved and coded data 17 provided by the interleaver 26.

Next, the packet multiplexer 28 sequentially provides the generated packets to a modulator 29, which converts the packetized data to a multiple access signal suitable for transmission over an uplink to an uplink receiver 21 using a radio frequency (RF) channel. In the preferred embodiment the packets generated by the packet multiplexer 28 are converted by the modulator 29 to use only one of two quadrature carriers, e.g., cos ω_{c}t or sin ω_{c}t. For example, the modulator 29 may use, e.g., pulse amplitude modulation (PAM) for applying multilevel amplitude modulation of the user data on one of the two quadrature carriers. If desired a known pseudo-noise code can be applied to the modulation so that it has the transmit characteristics of a quadrature signal. The known PN code may be removed at the uplink receiver 21.

Although the use of PAM in the modulator 29 reduces the number of possible bits per transmitted symbol by a factor of two when compared with a modulator using quadrature transmission, e.g., QAM, the bit error rate (BER) performance in this multibeam application is expected to be better for PAM because the user terminal transmitted signal is more resistant to interference when adaptive interference reduction is accomplished at the multiuser detector 23. This increased resistance to interference for PAM over QAM is more pronounced in unity reuse systems where there is a single central node 13 and a multibeam antenna, for example, the system and method disclosed in patent application SN/US00/12802. When multiple central nodes 13 are connected together with fixed communication links 14 for purposes of other user interference reduction (see example in FIG. 1), the performance advantage of PAM over QAM is less pronounced. The greater physical separation of antennas in the multiple central node configuration improves interference cancellation so that the degradation penalty with QAM is less significant. Because most conventional systems use quadrature axis modulations, it may be desirable to forego the BER improvement with PAM in order to maintain the same modulation structure. An alternative embodiment for the user terminal transmitter 12 therefore includes a modulator 29 with quadrature axis modulation.

Further, the modulator 29 preferably uses a different multiple access channel for each transmitted packet, i.e. modulation hopping transmissions. Modulation hopping is a generalized version of frequency hopping as used in FDMA/TDMA systems. In these systems the radio frequency channel assignment is changed for each user in each time slot. These hopping changes can be realized so as to maintain orthogonality between users in a beam/node region. The change to a different CDMA channel for each user in each time slot in a CDMA/TDMA system is another example of modulation hopping. The use of modulation hopping by each user terminal transmitter 12 insures that the interference from other users assigned to the same modulation-hopped channel changes for every packet. Subsequent deinterleaving and error-correction decoding after reception at the uplink receiver 21 will average over the other user interference. This averaging process eliminates the worse case interference pattern that can degrade communication quality. The use of frequency hopping in FDMA/TDMA systems to accomplish this interference averaging is well known in the art as it is a component in the wireless standard GSM used in European and other cellular networks. Finally, the modulator 29 provides the multiple access signal to an antenna 30 for transmission over an uplink to an uplink receiver 21 using an RF channel.

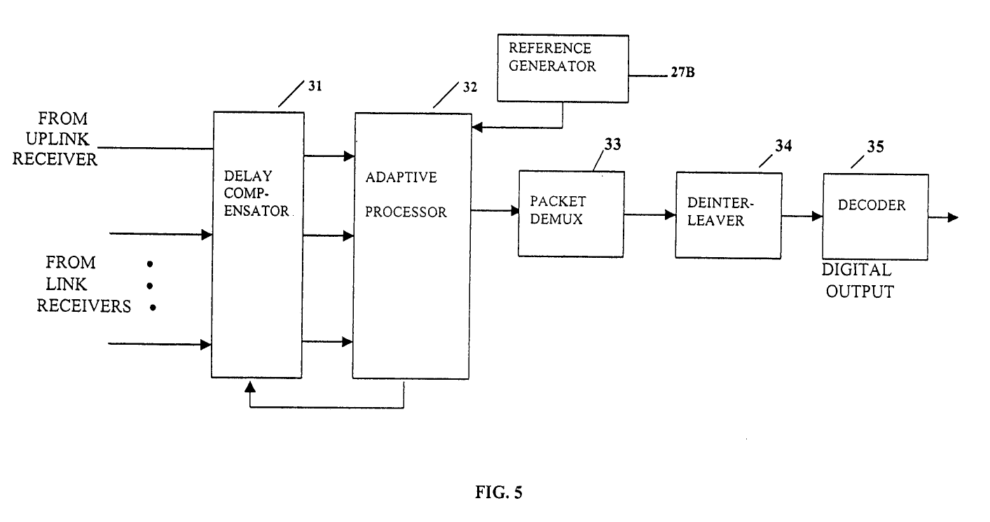

While the modulation hopping of users provides the potential for other user interference averaging, it also produces a random delay variation in the other user interference. When the user causing interference changes as a result of a modulation hop, the new user is in a different location. In a macrodiversity configuration where antennas are at different central node locations, the transmission paths between the new user and the antennas may change significantly relative to this previous user. These changes in delay may be as long as a few symbol durations and must be compensated at the multiuser detector 23. FIG. 5 shows a preferred embodiment of a multiuser detector 23 according to the present invention. The multiuser detector 23 accepts digitized beam/node signals associated with an assigned multiple access channel from the uplink receiver 21 as shown in FIG. 3. The beam/node signals includes multiple access signals on one or more antenna beams for the present central node, each beam including a set of users assigned to respective OMA channels. The uplink receiver 21 segregates user terminal signals by exploiting the mutual orthogonality of the multiple access channels. The multiuser detector 23 simultaneously produces recovered information signals for a plurality of users that are assigned the same multiple access channel and are in different beam/node regions.

For a central node with B antenna beams, the digitized signal from the uplink receiver 21 for each assigned multiple access channel contains B beam/node signals. An adjacent central node provides its digitized beam/node signals via the fixed communication network to a link receiver 24 as depicted in FIG. 3. Returning to FIG. 5, for a particular assigned multiple access channel, the beam/node signals from each of the adjacent central nodes are provided along with the B beam/node signals from the present central node to a delay compensator 31. Beam/node signals from adjacent central nodes are delayed relative to the present central node because of processing and transmission delay. Moreover adjacent central nodes may not be synchronous with the present central node. The delay compensator 31 adjusts the delays of beam/node signals from neighbor central nodes so that the beam/node signals corresponding to the assigned multiple access channel are approximately synchronized for the duration of the received packet. Since processing and transmission delay are known in advance, the delay adjustment due to these effects can be fixed. Compensation for slow timing changes due to asynchronism between central nodes requires delay measurements and adjustment of delay. This measurement is accomplished by correlation of user reference data 16 and beam/node signals in the adaptive processor 32. Delay adjustments are computed in the adaptive processor 32 and are provided to the delay compensator 31 as shown in FIG. 5. It should be understood that the delay compensation may also be accomplished in a distributed manner, for example, a synchronism correction at each central node and a processing/delay compensation at the multiuser detector.

For a particular assigned multiple access channel, if the antenna at the present central node has B beams and B beam/node signals and there are N beam/node signals from adjacent central nodes, there are D beam/node signals with significant mutual interference, wherein D≦B+N. The choice of D is dependent upon the required communications quality and the required complexity of the multiuser detector 23. The selected D beam/node signals from the delay compensator 31 are provided to a D-dimensional adaptive processor 32 for beam combining and other user interference reduction. For example in FIG. 1, there may be significant mutual interference from sectors 11A, 11B and 11C and from macrodiversity cells 11E and 11D so that D is five.

The adaptive processor 32 processes multiple beam/node signals and possibly previously detected digital symbols from K users, K81, and generates K combined signals with reduced mutual interference from the other users. The adaptive processor 32 may take the form of an adaptive equalizer that minimizes some error criterion, or an adaptive sequence estimator that finds the most likely transmitted digital symbol sequence for the user set assigned to the same multiple access channel, or some combination of both. Examples of adaptive equalizers that might be used in this multibeam application include linear minimum mean square error (MMSE) receivers, decorrelation detectors, and MMSE decision-feedback equalizers. The preferred embodiment is an adaptive equalizer that is based on the multiple diversity Decision-Feedback Equalizer (DFE) in “MMSE Equalization of Interference on Fading Diversity Channels”, P. Monsen, IEEE Transactions on Communications, vol. 32, no. 1, January 1984 [hereafter denoted by MMSE Equalization], the disclosure of which is hereby incorporated by reference. An example of known adaptive sequence estimation in this multiuser application is described in Adaptive Equalization and Interference Cancellation for Wireless Communication Systems, B. C. W. Lo and K. B. Letaief, IEEE Trans. Comm., vol. 47, no. 4, April 1999, pp. 538-545.

In the preferred embodiment of the adaptive processor 32, the combining for each of the K desired users is accomplished by using the replica of the reference signal of the desired user and replicas of reference signals for interfering users. To this end, for each user, the reference generator 27B provides a user-identifying replica of the reference signal, e.g., reference data 16, to the adaptive processor 32. The adaptive processor 32 exploits the user-identifying replicas to adapt its parameters and then generates K combined signals that correspond to users associated with a subset of the D beam/node signals.

The invention is first described for the condition that the central node clocks are mutually synchronized. For the synchronized condition the packets are approximately time aligned by the operation of the delay compensator 31 because all users regardless of their destination antenna, time their transmissions to arrive at the antennas simultaneously. After alignment of the beam/node signal components by the delay compensator 31 the interference must be equalized for time delay variations in order to effectively cancel or reduce the other user interference effect. The Multiuser Decision-Feedback Equalizer (MDFE) described below is the preferred embodiment of the adaptive processor 32 that provides this time-dispersed interference reduction as well as diversity combining of multipath dispersed desired signals.

Because of multipath and changes in delay to modulation hopped users, a transmittance function including these effects is defined as hᵢⱼ (l,q) representing the transmittance between user i and antenna j with a transmission delay of lT+qT/Q, l=0, 1, 2, . . . L, and q=0, 1, . . . , Q−1, and T is the transmitted symbol period. The representing of the transmittance in terms of a fraction of the symbol period is used in fractional-tapped adaptive equalizers in order to reduce equalization degradation in a bandlimited application. A typical value of Q is 2 as a compromise between reducing degradation and receiver complexity.

The equalizer weights in the forward and backward filter vectors of the MDFE can be determined from a compound matrix equation for K users, D antennas, L intersymbol interferers, Q fractional taps per symbol, NQ forward filter coefficients per antenna and L backward filter coefficients per user.

The received signal at the dth, d=1, 2, . . . , D, diversity antenna can be written as

$${r}_{d} ( iT + qT / Q ) = {\sum }_{k = 1}^{K} {\sum }_{l = 0}^{L} {h}_{dk} ( l , q ) {s}_{k} ( i - l ) + {u}_{d} ( i , q ) \qquad ( 1 )$$

where h_{dk} (l,q) is the transmittance between the kth user and the dth diversity antenna with a delay of (l+q/Q)T, q=0, 1, . . . , Q−1 and u_{d} (i, q) is an additive noise that is zero mean white complex Gaussian noise. The goal of the MDFE is to generate in each symbol period T a combined signal for each of the k=1, 2, . . . , K users, that for the ith symbol epoch and kth user corresponds to the transmitted digital symbol sₖ(i).

For a MDFE with NQ forward taps and cancellation of all past intersymbol interference, i.e. interference due to sₖ (i−l), l>0, k=1, 2, . . . , K, the forward filter signal can be expressed as a NQ×1 vector, i.e.,

r_{d}={r_{d}(iT+nT+qT/Q), n=0, 1, . . . , N−1; q=0, 1, . . . Q−1}

$${\underline{r}}_{d} = {\sum }_{k = 1}^{K} {A}_{dk} {\underline{s}}_{k} + {\sum }_{k = 1}^{K} {B}_{dk} {\underline{b}}_{k} + {\underline{u}}_{d} \qquad ( 2 )$$

The N×1 vector sₖ represents the user vector for present and future unknown digital symbols and the L×1 vector bₖ represent the user vector for previous decisions that are assumed correct and known in this mathematical development, viz.,

sₖ={sₖ(i+n),n=0, 1, Λ, N−1} (3)

bₖ={sₖ(i+n),n=−1, −2, Λ−L}

The forward A_{dk} and backward B_{dk} transmittance matrices are a function of the channel transmittance coefficients

A_{dk}(n,q:m)=h_{dk}(n−m,q) 0≦n≦N−1

0≦m≦N−1

0≦q≦Q−1 (4)

B_{dk}(n,q:l)=h_{dk}(n−l,q)−L≦l≦−1

where h_{dk}(l) is zero for l<0 and l>L.

The MDFE is adapted by estimating for each received signal packet the above channel transmittance coefficients. In the preferred embodiment the packet duration is sufficiently short that these coefficients are approximately constant. For longer packet durations it may be necessary to use multiple subpackets with either multiple subreference groups or a decision-directed tracking algorithm based on the estimates from the first reference group. The coefficients are estimated in the adaptive processor 32 by correlating the kth user reference signal with the dth diversity signal with a delay separation corresponding to the delay parameters specified in Eq. 4.

With these transmittance estimates one can write Eq. (2) in compound matrix form as a DQN×1 received vector

r=As+Bb+u (5)

where A={A_{dk}} is DQN×KN s={sₖ} is KN×1, B={B_{dk}} is DQN×KL, b={bₖ} is KL×1, and u is a zero mean DQN×1 vector with

\overline{uu′}=σ²I (6)

The noise variance σ² is estimated in the adaptive processor 32 during periods of signal absence as a calibration procedure or continuously in the presence of signal in an adaptive averaging technique that measures the minimum received power.

The optimum MDFE includes a matched filter whose output vector is

x=A′r=Hs+Fb+v QAM (7a)

For modulation constellations that are restricted to a single axis, the sufficient statistics are only in the real part of the matched filter output so for these constellations

x=Re(A′r)PAM (7b)

and H=Re (A′A), F=Re (A′B) where the Re (.) is omitted for QAM. The noise vector v has covariance matrix H. The MDFE minimizes the mean square error between the MDFE combined signal ŝₖ(i) and the k th user digital symbol value sₖ(i) for the k=1, 2, . . . , K users. The detected user combined signal value is

ŝₖ(i)=f′ₖx−g′ₖb k=1, 2, . . . , K (8)

where the kth user MDFE forward filter equalizer weight vector is

fₖ=M⁻¹eₖ, M=H+σ²I (8a)

and the kth user MDFE backward filter equalizer weight vector is

gₖ=F′fₖ (8b)

and

eₖ={eₖ(p), p=N(j−1)+n,1≦j≦K,0≦n≦N−1}={δⱼₖδ₀ₙ}

where

δⱼₖ=1 if j=k and 0 otherwise.

The matrix M is symmetric for PAM and Hermetian for QAM so that the solution for the forward filter equalizer weights, represented in (8a), can be obtained by a known Cholskey decomposition, e.g., as described in numerical computational texts such as “Least Square Estimation with Application to Digital Signal Processing” by A. A. Giordano and F. M. Hsu, John Wiley and Sons, New York, N.Y., 1985, Chapter 3.3. In this decomposition method the matrix M is decomposed into G′G where G′ is the complex conjugate transpose of G and G is a lower diagonal matrix, i.e. all the elements in the matrix above the diagonal are zero.

In the special case where the additive channel noise power σ² is taken as zero, this MMSE solution Eq. 8 reduces to a solution that cancels all the interference, i.e. a zero-forcing solution.

The cancellation of previous detected symbols in the K user MDFE can be augmented by linear equalization of an additional KL users. Each of these additional users is associated with one of the D beam/mode signals but the D beam/mode signals do not contain all of the beam/mode signals necessary for inclusion of these additional users into the multiuser detection set. This combination of decision-feedback and linear equalization is accomplished by augmenting the first term of Eq. 2 to include K_{L} additional interferers. The solution for the forward filter of the MDFE is still given by Eq. 8a but the vector fₖ, k=1, 2, . . . , K, is anticausal (future weights only) corresponding to a decision-feedback equalizer but this vector contains both future and past weights for K<k9K+K_{L} corresponding to a linear equalizer. In the limit for K=0 the multiuser detector is composed of K_{L} single-user linear equalizers.

When a multiple access channel is reused in all D beam/node regions, the MDFE processes D=K+K_{L} users. For the example of FIG. 1. where the D=5 beam/mode regions are sectors 11A, 11B, 11C and cells 11D and 11E, a multiuser detector at central mode 13A could simultaneously detect users from 11A, 11B, and 11C so K=3 and perform linear equalization on users in cells 11D and 11E so K_{L}=2.

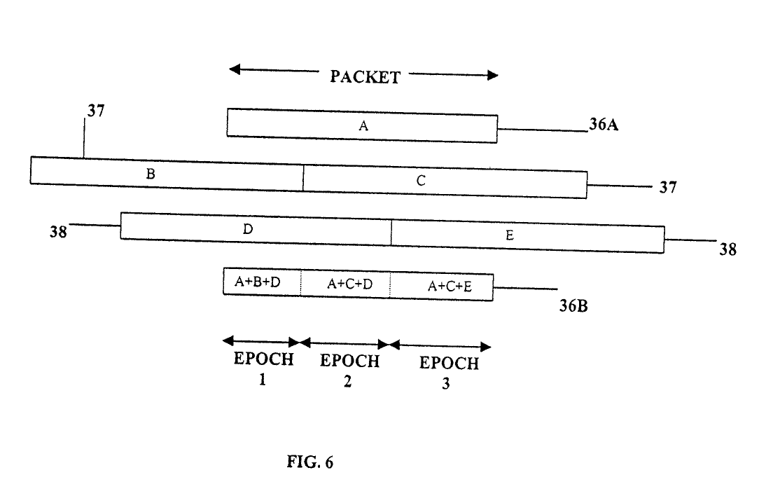

When the central nodes use mutually synchronized clocks, the packets of beam/node signals are approximately aligned after the delay adjustment of the delay compensator 31. When the central nodes do not use clocks that are mutually synchronized, an interference user associated with a different central node may change its multiple access channel in the middle of the packet time of the desired user group in the present central node. An example of asynchronous operation with three central nodes is shown in FIG. 6. The packet A, 36A, represents the received beam/node signals corresponding to a desired signal group of K users after delay compensation from all central nodes for which multiuser detection is to be employed. The packets B and C, 37, and packets D and E, 38, are interference signal packets from two neighbor central nodes after delay compensation. As a result of this clock asynchronism, there are time offsets as shown in FIG. 6. When the central node clocks are mutually synchronized the offset is small and can be compensated by the fractional tap structure of the MDFE. In this three node example, FIG. 6 shows that the interference packets 37 and 38 from neighbor central nodes result in three separate interference epochs in an interval 36B associated with the packet of the desired signal group. For example, in the first epoch if there are K_{LB}+K_{LD} users associated with the two neighbor central nodes, the MDFE during this epoch would be a K multiuser detector with linear equalization of the interference produced by the additional K_{LB}+K_{LD} users.

The embodiment of the invention for independent timing clocks at the central nodes includes the identification of these multiple epochs by the delay compensator 31 and the application of transmittance estimation and equalization as described above but applied separately in the multiple epochs. In general the number of epochs is equal to the number of macroscopic cells. A typical multicell configuration would be a combination of three macrocells each containing one or more beam sectors that would require a three epoch MDFE solution. The example given in FIG. 1 requires such a three epoch solution. It is anticipated that the continuing increase in signal processing capability will result in network solutions where multiple realization of the MDFE may be preferable to mutually synchronizing central node clocks over a large geographical area.

In FIG. 5 the combined signal for the kth user, k=1, 2, . . . , K, at the output of the adaptive processor 32 is then provided to a packet demultiplexer 33, which removes the reference data, e.g., reference data 1, from the combined signal. The packet demultiplexer 33 provides the combined signal without the reference data to a deinterleaver 34, which reverses the interleaving of the coded data performed by the interleaver 26. Finally, the deinterleaver 34 provides the deinterleaved data to a decoder 35, which performs error-correction decoding, thereby producing a digital output that is representative of the transmitted digital message information of the kth user terminal. Subsequent processing, e.g., digital-to-analog conversion (not shown), of the digital output may be required to obtain analog message information, e.g., voice signals, of the particular user.

While embodiments have been shown and described in accordance with the present invention, it is understood that the same is not limited thereto but is susceptible to numerous changes and modifications as known to a person skilled in this art. Accordingly, the present invention should not be limited to the detail shown and described herein but is intended to cover all such changes and modifications as are obvious to one of ordinary skill in this art.

Therefore, the present invention should be limited only by the spirit and scope of the appended claims.

What is claimed is:

1. A method of communicating digital data information from a plurality of user terminal transmitters, each of which is associated with a beam/node region corresponding to an antenna beam coverage region and a central node, to an uplink receiver with one or more antenna ports at the associated central node, wherein the central node is connected by a fixed communications network to one or more neighbor central nodes and a central processing location that contains a plurality of multiuser detectors each of which is associated with a multiple access channel assignment, comprising the steps of:
assigning a plurality of multiple access channels that belong to a mutually orthogonal set to a plurality of user terminal transmitters associated with a beam/node region and reusing the same multiple access channels for assignment to user terminal transmitters in other beam/node regions, each multiple access channel being associated with a reuse factor, which is defined by the number of user terminal transmitter assignments in different beam/node regions divided by the total number of beam/node regions;
adding, at the user terminal transmitter, error-correction coding to the digital data information to provide coded information;
interleaving, at the user terminal transmitter, the coded information among a plurality of data groups;
multiplexing with each data group, at the user terminal transmitter, a reference signal associated with the user terminal transmitter to provide a multiplexed signal;
modulating, at the user terminal transmitter, the multiplexed signal with a multiple access waveform associated with the assigned multiple access channel to provide a multiple access signal;
transmitting, at the user terminal transmitter, the multiple access signal;
receiving, at one or more antenna ports at the uplink receiver, the multiple access signals from user terminal transmitters associated with the same multiple access channel assignment so as to provide one or more associated beam/node signals;
transferring the central node and neighbor central node beam/node signals via the fixed communications network to the associated multiuser detector;
generating, at the multiuser detector, a plurality of user-identifying replicas of the reference signals associated with user terminal transmitters;
jointprocessing, at the multiuser detector, the associated beam/node signals with user-identifying replicas to provide a plurality of combined signals each associated with a user terminal transmitter, thereby reducing mutual interference from user terminal transmitters in different beam/node regions with the same assigned multiple access channel;
deinterleaving and decoding, at the multiuser detector, each of the combined signals to recover the associated user terminal transmitter digital data information.

2. The method of claim 1 wherein the transferring step further includes:
time aligning the beam/node signals.

3. The method of claim 2 wherein the modulating step further includes:
modifying in a random or pseudo-random manner the radio frequency characteristics of the multiple access signal for the duration of the multiplexed signal corresponding to each data group.

4. The method of claim 3 wherein the joint processing step further includes:
correlating combinations of user-identifying replicas with beam/node signals to provide a plurality of user/beam transmittance values;
calculating the product of transmittance values and beam/node signals to provide a plurality of matched beam/node signals;
converting transmittance values into equalizer weights;
summing the product of equalizer weights and matched beam/node signals, thereby producing the combined signal.

5. The method of claim 4 wherein the converting step further includes:
solving a set of simultaneous equations with a Cholskey decomposition.

6. The method of claim 1 wherein the joint processing step further includes:
correlating combinations of user-identifying replicas with beam/node signals to provide a plurality of user/beam transmittance values;
calculating the product of transmittance values and beam/node signals to provide a plurality of matched beam/node signals;
converting transmittance values into equalizer weights;
summing the product of equalizer weights and matched beam/node signals, thereby producing the combined signal.

7. The method of claim 6 wherein the converting step further includes:
solving a set of simultaneous equations with a Cholskey decomposition.

8. The method of claim 3 wherein the modulating step further includes:
utilizing only one of the two quadrature axes.

9. The method of claim 1 wherein the assigning step further includes:
reusing at least one multiple access channel in all beam/node regions so that its reuse factor is unity.

10. The method of claim 1 wherein central nodes are independently time synchronized and wherein the joint processing step further includes:
partitioning the data group into a plurality of time epochs each of which has independent processing.

11. A communication system for communicating digital data information from a plurality of user terminals, each of which is associated with a beam/node region corresponding to an antenna beam coverage region and a central node, to an antenna with one or more antenna ports at the associated central node, wherein each central node is connected by communication links to one or more neighbor central node, comprising:
a controller disposed at a central node or distributed within the communication system, that assigns a plurality of multiple access channels that belong to a mutually orthogonal set to the plurality of user terminals associated with a beam/node region, and each multiple access channel is assigned at most once in each of the different beam/node regions;
a user terminal transmitter disposed at the user terminal that transmits digital data information in a multiple access signal to the associated central node;
an error-correction coder disposed at the user terminal that adds error-correction coding to the digital data information to provide coded information;
an interleaver disposed at the user terminal that interleaves the coded information among a plurality of data groups;
a multiplexer disposed at the user terminal that adds to each data group a reference signal associated with the user terminal transmitter to provide a multiplexed signal;
a modulator disposed at the user terminal that operates on the multiplexed signal with a multiple access waveform associated with the assigned multiple access channel to provide a multiple access signal;
an uplink receiver disposed at the central node that receives on the one or more antenna ports the multiple access signals from user terminal transmitters associated with the same multiple access assignment so as to provide a plurality of associated beam/node signals;
link receivers disposed at the central node that receive associated beam/node signals from neighbor central nodes;
a reference generator disposed at the central node that generates a plurality of user-identifying replicas of the reference signal associated with user terminal transmitters;
a multiuser detector disposed at the central node that processes the associated beam/node signals and user-identifying replicas to provide a plurality of combined signals each associated with a user terminal transmitter, thereby reducing mutual interference from user terminal transmitters in different beam/node regions assigned the same multiple access channel,
a deinterleaver disposed at the central node that deinterleaves at least one combined signal; and
a decoder disposed at the central node that recovers the user terminal transmitter digital data information.

12. A communication system according to claim 11 wherein the multiuser detector further includes:
a delay compensator for time aligning the associated beam/node signals.

13. A communication system according to claim 12 wherein the modulator further includes:
means for modifying in a random or pseudo-random manner the radio frequency characteristics of the multiple access signal for the duration of the multiplexed signal corresponding to each data group.

14. A communication system according to claim 13 wherein the multiuser detector further includes:
means for correlating combinations of user-identifying replicas with beam/node signals to provide a plurality of user/beam transmittance values, and
means for calculating the product of transmittance values and beam/node signals to provide a plurality of matched beam/node signals, and
conversion means for converting transmittance values into equalizer weights, and
means for summing the product of equalizer weights and matched beam/node signals, thereby producing the combined signal.

15. A communication system according to claim 14 wherein the conversion means further includes:
means for solving a set of simultaneous equations with a Cholskey decomposition.

16. A communication system according to claim 11 wherein the multiuser detector further includes:
means for correlating combinations of user-identifying replicas with beam/node signals to provide a plurality of user/beam transmittance values, and
means for calculating the product of transmittance values and beam/node signals to provide a plurality of matched beam/node signals, and
conversion means for converting transmittance values into equalizer weights, and
means for summing the product of equalizer weights and matched beam/node signals, thereby producing the combined signal.

17. A communication system according to claim 16 wherein the conversion means further includes:
means for solving a set of simultaneous equations with a Cholskey decomposition.

18. A communication system according to claim 13 wherein the modulator further includes:
means for utilizing only one of the two quadrature axes.

19. A method for receiving and processing digital information transmitted from a plurality of user terminals, each of which is associated with a beam/node region corresponding to an antenna beam coverage region and a central node, to the associated central node with an uplink receiver with one or more antenna port inputs and at least one link receiver connected via a fixed communications network to a neighbor central node, and each user terminal transmits a user-identifying reference and digital data information that is error-corrected coded and interleaved in a modulated signal associated with a multiple access channel that belongs to a mutually orthogonal set, comprising the steps of:
assigning a multiple access channel to a first user terminal in a first beam/node region of a first central node and assigning the same multiple access channel to a second user terminal in a second beam/node region of a neighbor central node and the user/beam transmittance attenuation between the first and second user terminals is unrestricted;
receiving, at the uplink receiver of the associated central node, the modulated signals from the user terminal so as to provide one or more beam/node signals each corresponding to an antenna port input;
transferring, to the first central node via the fixed communications network and the link receiver, one or more neighbor central node beam/node signals associated with the second user terminal;
synchronizing, at the first central node, the central node and neighbor central node beam/node signals to provide time-aligned beam/node signals;
generating, at the first central node, user-identifying replicas of the reference signals associated with the first and second user terminals;
processing, at the first central node, the time-aligned beam/node signals and the user-identifying replicas to provide a combined signal associated with the first user terminal, thereby reducing interference from the second user terminal;
deinterleaving and decoding,. at the first central node, the combined signal to recover the first user terminal digital information.

20. The method of claim 19 wherein the processing step further includes:
correlating combinations of the user-identifying replicas with beam/node signals to provide a plurality of user/beam transmittance values;
calculating the product of transmittance values and beam/node signals to provide a plurality of matched beam/node signals;
converting transmittance values into equalizer weights;
summing the product of equalizer weights and matched beam/node signals, thereby producing the combined signal.

21. The method of claim 20 wherein the converting step further includes:
solving a set of simultaneous equations with a Cholskey decomposition.

22. The method of claim 19 wherein the second central node employs a timing clock that is independent of the timing clock in the first central node and wherein the processing step further includes:
partitioning the data group into at least two time epochs each of which has independent processing.
